(19) United States
(12) Patent Application Publication
(10) Pub. No.: US 2025/0357980 A1
(43) Pub. Date: Nov. 20, 2025

(54) METHOD AND DEVICE FOR PERFORMING DATA LEARNING IN WIRELESS COMMUNICATION SYSTEM

(71) Applicants: LG ELECTRONICS INC., Seoul (KR); THE UNIVERSITY OF HONG KONG, Hong Kong (CN)

(72) Inventors: Kijun JEON, Seoul (KR); Dingzhu WEN, Shanghai (CN); Kaibin HUANG, Hong Kong (CN); Sangrim LEE, Seoul (KR)

(73) Assignees: LG ELECTRONICS INC., Seoul (KR); THE UNIVERSITY OF HONG KONG, Hong Kong (CN)

(21) Appl. No.: 18/291,879

(22) PCT Filed: May 17, 2022
(86) PCT No.: PCT/KR2022/007049

§ 371 Date: Feb. 5, 2025

(30) Foreign Application Priority Data
Aug. 2, 2021 (KR) 10-2021-0101487

(51) Int. Cl. H04B 7/06; H04L 5/00

(52) U.S. Cl. CPC H04B 7/0626; H04L 5/0048

(57) ABSTRACT

Disclosed herein is a method for operating a terminal in a wireless communication system, and the method may include receiving, by the terminal, a reference signal for measuring channel state information from a base station, performing, by the terminal, measurement based on the received reference signal, performing measurement report based on the performed measurement to the base station, and performing learning by receiving information on a dropout rate and a subnet which are determined by the base station based on the measurement report.

### CROSS-REFERENCE TO RELATED APPLICATION(S)

This application is the National Stage filing under 35 U.S.C. 371 of International Application No. PCT/KR2022/007049, filed on May 17, 2022, which claims the benefit of earlier filing date and right of priority to Korean Application No. 10-2021-0101487, filed on Aug. 2, 2021, the contents of which are all incorporated by reference herein in their entirety.

### TECHNICAL FIELD

The present disclosure relates to a wireless communication system, and more particularly, to a method and device for performing data learning in a wireless communication system.

In particular, the present disclosure relates to a method and device for performing learning through a plurality of terminals based on federated learning.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure relates to a method and device for performing data learning in a wireless communication system.

The present disclosure relates to a method and device for determining a dropout rate and a subnet based on federated learning in a wireless communication system.

The present disclosure relates to a method and device for performing learning through each terminal based on a dropout rate and a subnet determined in a wireless communication system.

The present disclosure relates to a method for updating a global model of a base station based on model information learnt through each terminal in a wireless communication system.

The technical objects to be achieved in the present disclosure are not limited to the above-mentioned technical objects, and other technical objects that are not mentioned may be considered by those skilled in the art, to which a technical configuration of the present disclosure is applied, through the embodiments described below.

As an example of the present disclosure, a method for operating a terminal in a wireless communication system may comprise: receiving, by the terminal, a reference signal for measuring channel state information from a base station, performing, by the terminal, measurement based on the received reference signal, performing measurement report based on the performed measurement to the base station, and performing learning by receiving information on a dropout rate and a subnet which are determined by the base station based on the measurement report.

As an example of the present disclosure, a method for operating base station in a wireless communication system may comprise: transmitting, by the base station, a reference signal for measuring channel state information to at least one or more terminals, receiving measured measurement report information from the at least one or more terminals, determining a dropout rate and a subnet for the at least one or more terminals, and transmitting information on the determined dropout rate and subnet to the at least one or more terminals.

As an example of the present disclosure, a terminal in a wireless communication system may comprise: a transceiver; and a processor coupled with the transceiver, wherein the processor is configured to: receive, by using the transceiver, a reference signal for measuring channel state information from a base station, perform measurement based on the received reference signal, perform measurement report based on the performed measurement to the base station, and perform learning by receiving information on a dropout rate and a subnet which are determined by the base station based on the measurement report

As an example of the present disclosure, a base station in a wireless communication system, may comprise: a transceiver; and a processor coupled with the transceiver, wherein the processor is configured to: transmit, by using the base station, a reference signal for measuring channel state information to at least one or more terminals, receive measured measurement report information from the at least one or more terminals, determine a dropout rate and a subnet for the at least one or more terminals, and transmit information on the determined dropout rate and subnet to the at least one or more terminals.

As an example of the present disclosure, a device may comprise at least one memory and at least one processor coupled functionally with the at least one memory, wherein the at least one processor controls the device to: receive a reference signal for measuring channel state information from a base station, perform measurement based on the received reference signal, perform measurement report based on the performed measurement to the base station, and perform learning by receiving information on a dropout rate and a subnet which are determined by the base station based on the measurement report.

As an example of the present disclosure, a non-transitory computer-readable medium storing at least one instruction, may comprise the at least one instruction executable by a processor, wherein the at least one instruction is configured to:
receive a reference signal for measuring channel state information from a base station, perform measurement based on the received reference signal, perform measurement report based on the performed measurement to the base station, and perform learning by receiving information on a dropout rate and a subnet which are determined by the base station based on the measurement report.

As an example of the present disclosure, wherein the dropout rate may be determined for each terminal by the base station through a policy for determining the dropout rate.

As an example of the present disclosure, wherein the policy may be determined based on at least one of channel information, terminal capability information, power information of the base station, and radio resource information.

As an example of the present disclosure, wherein the base station may have a global model which is determined based on at least one of fully connected neural networks (NNs) and fully connected layers in a DNN.

As an example of the present disclosure, wherein the subnet may be determined by randomly dropping out some nodes based on the dropout rate in the global model.

As an example of the present disclosure, wherein the terminal may be construct a local model based on the subnet information on the terminal and perform learning through a local dataset obtained based on the constructed local model.

As an example of the present disclosure, wherein the terminal may forward information on the performed learning based on the local dataset to the base station, and wherein the base station may update the global model based on each piece of learning information received from each of terminals.

As an example of the present disclosure, wherein an update for the global model, which the base station has, may be performed at each round, wherein the terminal receives a learning participation request message for learning of a first round, and wherein, based on the terminal being capable of participating in the learning of the first round, the terminal may transmit a response message for learning participation permission to the base station.

As an example of the present disclosure, wherein the terminal may determine whether to participate in the learning of the first round, based on at least one of a generated local dataset and capability of the terminal.

As an example of the present disclosure, wherein, based on the terminal transmitting the response message for learning participation permission to the base station, the terminal may transmit information on the capability of the terminal and volume information of the local dataset to the base station together.

As an example of the present disclosure, wherein the information on the capability of the terminal may be determined by considering at least one of a clock frequency, a battery, and available transmission power information of the terminal.

As an example of the present disclosure, wherein the base station may be at least one of a server, an edge server, an access point, and an entity with a global model.

The following effects may be produced by embodiments based on the present disclosure.

In embodiments based on the present disclosure, it is possible to provide a method for performing data learning.

In embodiments based on the present disclosure, it is possible to provide a method for reducing traffic overhead that occurs in federated learning.

In embodiments based on the present disclosure, it is possible to provide a method for reducing communication latency overhead and computing overhead that occur in federated learning.

In embodiments based on the present disclosure, it is possible to provide a method for efficiently performing federated learning.

Effects obtainable from embodiments of the present disclosure are not limited to the above-mentioned effects, and other effects not mentioned above may be clearly derived and understood by those skilled in the art, to which a technical configuration of the present disclosure is applied, from the following description of embodiments of the present disclosure.

That is, effects, which are not intended when implementing a configuration described in the present disclosure, may also be derived by those skilled in the art from the embodiments of the present disclosure.

### BRIEF DESCRIPTION OF THE DRAWINGS

The accompanying drawings are provided to aid understanding of the present disclosure, and embodiments of the present disclosure may be provided together with a detailed description. However, the technical features of the present disclosure are not limited to a specific drawing, and features disclosed in each drawing may be combined with each other to constitute a new embodiment. Reference numerals in each drawing may mean structural elements.

FIG. 1 is a view showing an example of a communication system applicable to the present disclosure.

FIG. 2 is a view showing an example of a wireless device applicable to the present disclosure.

FIG. 3 is a view showing another example of a wireless device applicable to the present disclosure.

FIG. 4 is a view showing an example of artificial intelligence (AI) device applicable to the present disclosure.

FIG. 5 is a view showing federated learning according to an embodiment of the present disclosure.

FIG. 6 is a view showing a method for performing federated learning according to an embodiment of the present disclosure.

FIG. 7 is a view showing a method for performing federated learning based on a dropout rate according to an embodiment of the present disclosure.

FIG. 8 is a view showing a method for performing federated learning based on a dropout rate according to an embodiment of the present disclosure.

FIG. 9 is a view showing a method for operating a terminal participating in federated learning according to an embodiment of the present disclosure.

FIG. 10 is a view showing a method for performing learning by determining a dropout rate in a terminal according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

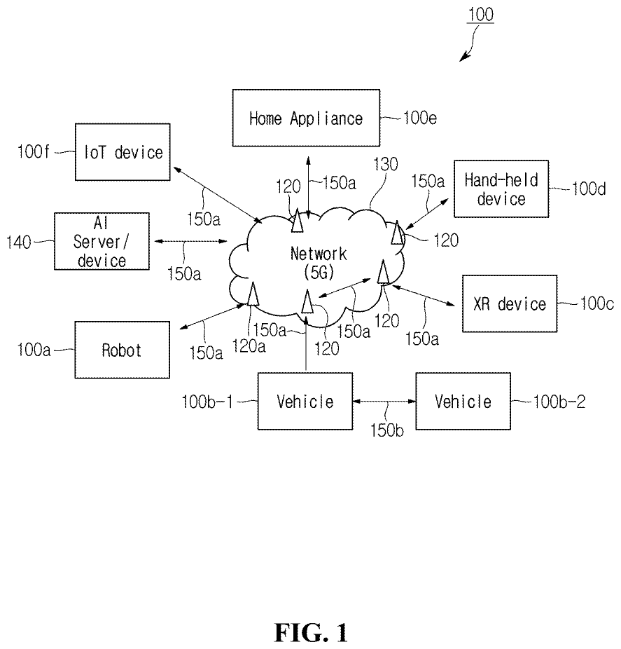

FIG. 1 is a view showing an example of a communication system applicable to the present disclosure.

Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

### Wireless Device Applicable to the Present Disclosure

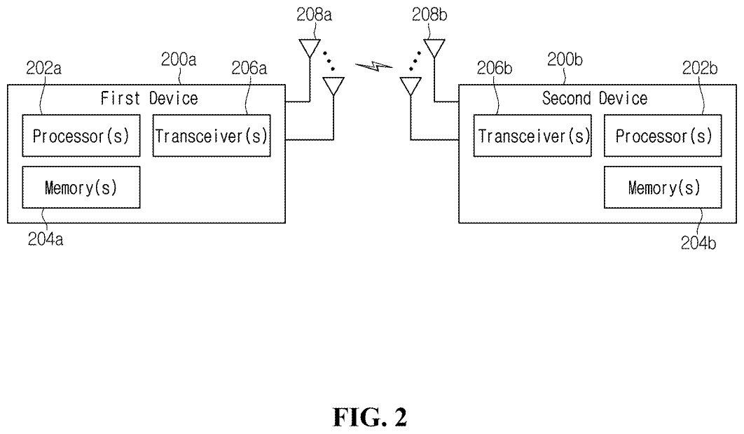

FIG. 2 is a view showing an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be coupled with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be coupled with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be coupled with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be coupled with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters

### Structure of Wireless Device Applicable to the Present Disclosure

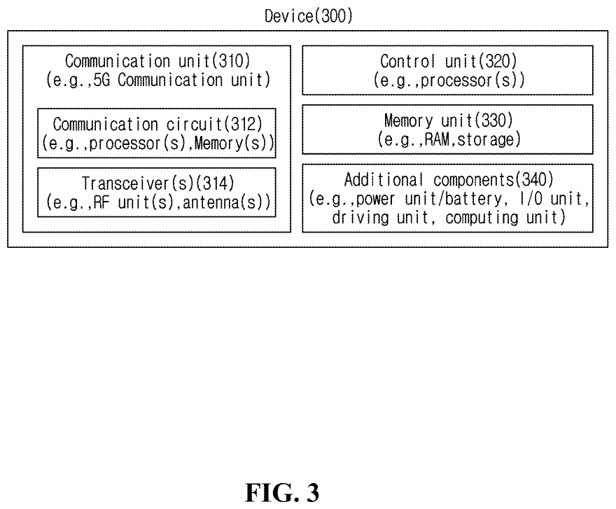

FIG. 3 is a view showing another example of a wireless device applicable to the present disclosure.

Referring to FIG. 3, a wireless device 300 may correspond to the wireless devices 200a and 200b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202a and 202b and/or one or more memories 204a and 204b of FIG. 2. For example, the transceiver(s) 314 may include one or more transceivers 206a and 206b and/or one or more antennas 208a and 208b of FIG. 2. The control unit 320 may be electrically coupled with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be coupled with each other through wired interfaces or at least some thereof may be wirelessly coupled through the communication unit 310. For example, in the wireless device 300, the control unit 320 and the communication unit 310 may be coupled by wire, and the control unit 320 and the first unit (e.g., 130 or 140) may be wirelessly coupled through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

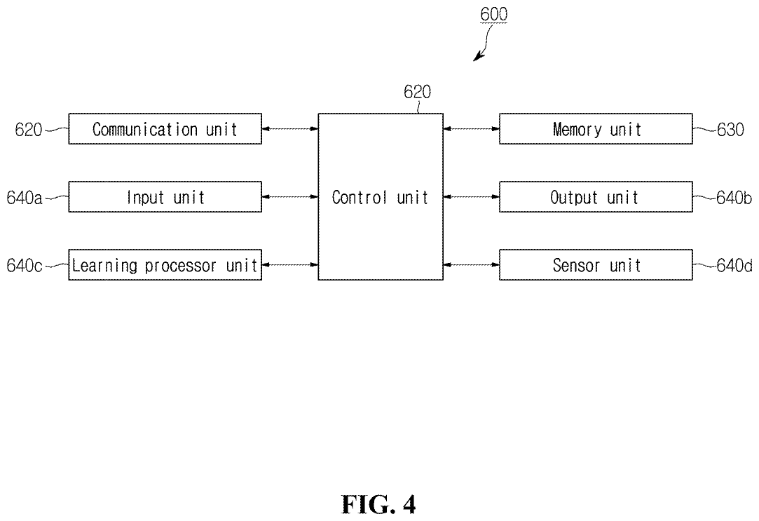

FIG. 4 is a view showing an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

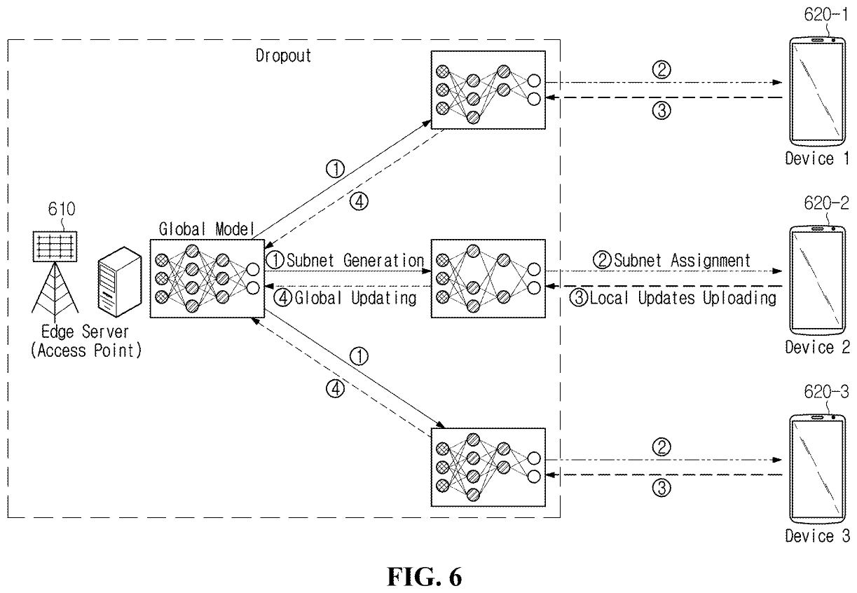

Referring to FIG. 6, the AI device 600 may include a communication unit (transceiver) 610, a control unit (controller) 620, a memory unit (memory) 630, an input/output unit 640a/640b, a leaning processor unit (learning processor) 640c and a sensor unit 640d. The blocks 610 to 630/640a to 640d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640c or transmit the history information to the AI server (FIG. 1, 140). The collected history information may be used to update a learning model.

The memory unit 630 may store data supporting various functions of the AI device 600. For example, the memory unit 630 may store data obtained from the input unit 640a, data obtained from the communication unit 610, output data of the learning processor unit 640c, and data obtained from the sensing unit 640. In addition, the memory unit 630 may store control information and/or software code necessary to operate/execute the control unit 620.

The input unit 640a may acquire various types of data from the outside of the AI device 600. For example, the input unit 640a may acquire learning data for model learning, input data, to which the learning model will be applied, etc. The input unit 640a may include a camera, a microphone and/or a user input unit. The output unit 640b may generate video, audio or tactile output. The output unit 640b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640c may train a model composed of an artificial neural network using training data. The learning processor unit 640c may perform AI processing along with the learning processor unit of the AI server (FIG. 1, 140). The learning processor unit 640c may process information received from an external device through the communication unit 610 and/or information stored in the memory unit 630. In addition, the output value of the learning processor unit 640c may be transmitted to the external device through the communication unit 610 and/or stored in the memory unit 930.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 1 below. That is, Table 1 shows the requirements of the 6G system.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

### Artificial Intelligence (AI)

Technology which is most important in the 6G system and will be newly introduced is AI. AI was not involved in the 4G system. A 5G system will support partial or very limited AI. However, the 6G system will support AI for full automation. Advance in machine learning will create a more intelligent network for real-time communication in 6G. When AI is introduced to communication, real-time data transmission may be simplified and improved. AI may determine a method of performing complicated target tasks using countless analysis. That is, AI may increase efficiency and reduce processing delay.

Time-consuming tasks such as handover, network selection or resource scheduling may be immediately performed by using AI. AI may play an important role even in M2M, machine-to-human and human-to-machine communication. In addition, AI may be rapid communication in a brain computer interface (BCI). An AI based communication system may be supported by meta materials, intelligent structures, intelligent networks, intelligent devices, intelligent recognition radios, self-maintaining wireless networks and machine learning.

Recently, attempts have been made to integrate AI with a wireless communication system in the application layer or the network layer, but deep learning have been focused on the wireless resource management and allocation field. However, such studies are gradually developed to the MAC layer and the physical layer, and, particularly, attempts to combine deep learning in the physical layer with wireless transmission are emerging. AI-based physical layer transmission means applying a signal processing and communication mechanism based on an AI driver rather than a traditional communication framework in a fundamental signal processing and communication mechanism. For example, channel coding and decoding based on deep learning, signal estimation and detection based on deep learning, multiple input multiple output (MIMO) mechanisms based on deep learning, resource scheduling and allocation based on AI, etc. may be included.

Machine learning may be used for channel estimation and channel tracking and may be used for power allocation, interference cancellation, etc. in the physical layer of DL. In addition, machine learning may be used for antenna selection, power control, symbol detection, etc. in the MIMO system.

However, application of a deep neutral network (DNN) for transmission in the physical layer may have the following problems.

Deep learning-based AI algorithms require a lot of training data in order to optimize training parameters. However, due to limitations in acquiring data in a specific channel environment as training data, a lot of training data is used offline. Static training for training data in a specific channel environment may cause a contradiction between the diversity and dynamic characteristics of a radio channel.

In addition, currently, deep learning mainly targets real signals. However, the signals of the physical layer of wireless communication are complex signals. For matching of the characteristics of a wireless communication signal, studies on a neural network for detecting a complex domain signal are further required.

Hereinafter, machine learning will be described in greater detail.

Machine learning refers to a series of operations to train a machine in order to build a machine which can perform tasks which cannot be performed or are difficult to be performed by people. Machine learning requires data and learning models. In machine learning, data learning methods may be roughly divided into three methods, that is, supervised learning, unsupervised learning and reinforcement learning.

Neural network learning is to minimize output error. Neural network learning refers to a process of repeatedly inputting training data to a neural network, calculating the error of the output and target of the neural network for the training data, backpropagating the error of the neural network from the output layer of the neural network to an input layer in order to reduce the error and updating the weight of each node of the neural network.

Supervised learning may use training data labeled with a correct answer and the unsupervised learning may use training data which is not labeled with a correct answer. That is, for example, in case of supervised learning for data classification, training data may be labeled with a category. The labeled training data may be input to the neural network, and the output (category) of the neural network may be compared with the label of the training data, thereby calculating the error. The calculated error is backpropagated from the neural network backward (that is, from the output layer to the input layer), and the connection weight of each node of each layer of the neural network may be updated according to backpropagation. Change in updated connection weight of each node may be determined according to the learning rate. Calculation of the neural network for input data and backpropagation of the error may configure a learning cycle (epoch). The learning data is differently applicable according to the number of repetitions of the learning cycle of the neural network. For example, in the early phase of learning of the neural network, a high learning rate may be used to increase efficiency such that the neural network rapidly ensures a certain level of performance and, in the late phase of learning, a low learning rate may be used to increase accuracy.

The learning method may vary according to the feature of data. For example, for the purpose of accurately predicting data transmitted from a transmitter in a receiver in a communication system, learning may be performed using supervised learning rather than unsupervised learning or reinforcement learning.

The learning model corresponds to the human brain and may be regarded as the most basic linear model. However, a paradigm of machine learning using a neural network structure having high complexity, such as artificial neural networks, as a learning model is referred to as deep learning.

Neural network cores used as a learning method may roughly include a deep neural network (DNN) method, a convolutional deep neural network (CNN) method and a recurrent Boltzmman machine (RNN) method. Such a learning model is applicable.

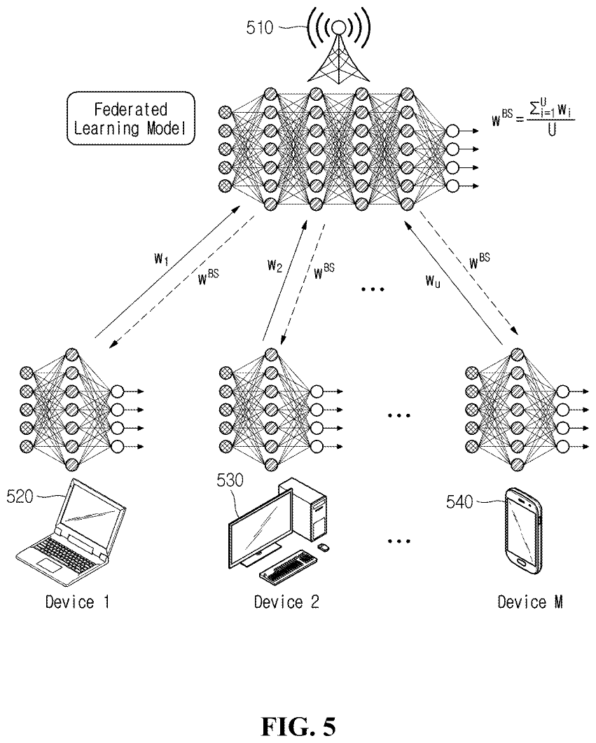

As an example, FIG. 5 is a view showing federated learning according to an embodiment of the present disclosure. Referring to FIG. 5, a method for making distributed AI learning efficient in a mobile communication system may be provided. In case data for a plurality of terminals are distributed, a centralized learning method may be a scheme in which each of the terminals forwards its data to a base station and learning is performed in the base station.

However, such centralized learning, in which data of terminals are sent to a base station or a server, may have a limitation in data security. Accordingly, a wireless federated learning method may be needed as a distributed learning method that does not send data of a user. Herein, the wireless federated learning method may be a method that enables each terminal to perform individual learning and transmit a local model update to a base station, instead of transmitting data of each terminal to the base station. Herein, the base station may transmit an aggregate value of local model updates based on the received local model updates to each terminal. Herein, the above-described process may be continuously repeated, and distributed learning may be performed by federation of terminals.

Herein, since a size of a local model is frequently large, in case terminals participating in learning transmit information on a local model via an uplink channel by using an independent radio resource, a radio resource loss may be great. Accordingly, the over-the-air computing (Aircomp) technique may be used where terminals send local instantaneous models via an uplink by using a same radio resource and then the models are automatically combined over the air.

As an example, the Aircomp technique may be a method of applying and transmitting a weight inversely proportional to a radio channel in order to combine local models sent by each of the terminals in a same size.

As a concrete example, a model parameter of federated learning may be applied to a new communication system. Federated learning may be applied to any one case of protection of personal privacy, load reduction of a base station through distributed processing, and reduction of traffic between a base station and a terminal. However, it may not be limited thereto. Herein, as an example, traffic of a local model parameter (e.g. weight of a deep neural network, information) may impose a heavy burden on a wireless communication environment, and in consideration of this, the above-described compression or Aircomp (Over the Air Computing) of local model parameters may reduce the traffic.

However, a communication system may have a variety of wireless communication environments. In addition, the number of terminals requiring learning may be set in various ways in a communication system. Herein, considering the above-described environment, a communication system may need a flexible operating method and system, not a fixed specific technique. Thus, resource efficiency of a communication system may be enhanced. As an example, a federated learning method through Aircomp may be a method of combining terminal model parameters. In case transmission is performed based on Aircomp, since a wireless communication channel performs transmission of a signal based on superposition, transmission efficiency may be improved, and the load on a base station may be reduced. In addition, terminals may share a same communication channel. Accordingly, in case there are a plurality of terminals, transmission efficiency may be improved.

In consideration of what is described above, a federated learning method through terminal model parameter compression may be a method in which each terminal performs compression of data by considering a characteristic of a parameter and transmits compressed data to a base station. Accordingly, in case a base station receives a signal based on a federated learning method, the base station needs to perform an operation of decompressing and adding up collected parameters, and a load of the base station may be increased. In addition, as an example, because a communication channel is to be allocated according to each number of terminals, communication traffic may increase in proportion to the number of used terminals. Accordingly, in case there are a plurality of terminals, a compression-based method may decrease efficiency.

As an example, in case a weighted signaling method is fixedly used in a federated learning scheme, efficiency may be different based on a wireless environment. As an example, efficiency may be high in a specific environment, but efficiency may be rather lowered in the opposite case. Because a wireless environment may flexibly change, it is necessary to recognize a wireless environment flexibly changing and select a technique based on the recognized wireless environment. Hereinafter, an operation based on the above description will be described to improve the efficiency of a wireless environment.

As an example, each terminal may forward a parameter (e.g., weight of a deep neural network, information) of a model trained based on a federated learning scheme to a base station. Each terminal may forward a compressed parameter, and the base station may update a global model based on Equation 1 below. Here, c may be information compression and modulation processing, and d may be demodulation and information restoration process. Then, the base station may forward the updated global model to each terminal.

$$g = \frac{{\sum }_{i = 1}^{M} d ( c ( {z}_{i} ) )}{M} \qquad [ Equation 1 ]$$

Specifically, each terminal may perform compression based on a method of minimizing an amount of model parameters. As an example, the compression may be performed based on at least any one of weight pruning, quantization, and weight sharing. In addition, as an example, the compression may be performed based on another method and is not limited to the above-described embodiment. Herein, in case the compression is performed based on an existing neural network, a value necessary for actual inference among weights may be resistant to small values. That is, a weight value necessary for actual inference may have a small impact on small values. In consideration of what is described above, weight pruning may set all the small weight values to 0. Thus, a neural network may reduce a network model size. In addition, as an example, quantization may be a computing method that reduces data into a specific number of bits. That is, data may be expressed only into a specific quantized value. In addition, as an example, weight sharing may be a method of adjusting weight values based on an approximate value (e.g. codebook) and making the values shared. Herein, in case a signal is transmitted in the network, the information may be shared with respect only to a codebook and an index for a corresponding value.

Based on any one of the above-described methods, each terminal may perform compression of data and transmit compressed data to a base station. Herein, the base station may receive compressed “ [symbol] c(z [symbol] _k)” from each terminal, decompress the received data, calculate a parameter of a global model, and update it.

Herein, each terminal may set a local model parameter with an individual characteristic. Accordingly, when each terminal performs compression, compression efficiency may be different according to each terminal. In addition, as an example, each terminal may have a different hardware resource. Herein, compression efficiency may be influenced by a hardware resource. Accordingly, each terminal may have different compression efficiency.

As a concrete example, in case a terminal performs quantization in 8 bits, a terminal with 64-bit arithmetic processing function may obtain high compression efficiency. On the other hand, a terminal with a 16-bit arithmetic processing function may have low compression efficiency. In addition, as an example, when a terminal has low-specification hardware, the terminal may receive a large compression load. Accordingly, it may be advantageous for the terminal to use a simple compression technique. As an example, since an Internet-of-Thing (IoT) terminal or low-power terminals may have relatively low-specification hardware, they may use a simple compression technique. On the other hand, since a terminal operated based on an AI or a terminal processing a massive amount of data may have high-specification hardware, compression efficiency may be enhanced by using a complex compression technique. That is, a different compression method may be used according to each terminal, and it may be necessary to use a compression method suitable for each terminal.

In consideration of what is described above, each terminal may use a compression method suitable for an individual characteristic of a local model parameter and a hardware resource. Herein, terminals may have to forward information on a compression method to a base station. Based on the information received from the terminal, the base station may restore compressed data and a model parameter which are received from each terminal.

Hereinafter, a method for efficiently performing federated learning by a terminal will be described. As an example, federated learning may be performed as described above, based on the capability of a terminal participating in the federated learning. As an example, as described above, federated learning is performed mainly by efficiently managing communication and computation (C²) overhead through adjustment of an amount of learning of each terminal or through model partitioning of a target learning model under the assumption that the capability of a terminal is sufficient.

However, in a resource-constrained system, learning needs to be dynamically operated in order to reduce the above-described C² overhead, and a method therefor will be described below. As an example, hereinafter, a method of efficiently performing federated learning by using resource-constrained devices will be described. As an example, a dropout rate for each terminal may be determined, a subnet (or subset) may be generated based on the determined dropout rate, and then learning may be performed based on the subnet. A dropout rate may be derived according to a policy based on C² overhead analysis derived based on a given requirement. As an example, the given requirement may be set based on at least any one of round latency, channel gain, bandwidth, and DL/UL power, but may not be limited thereto. That is, a dropout policy may be determined according to C² overhead derived in consideration of each requirement given based on the above-described information, and a dropout rate may be determined based on the determined dropout policy.

In case each terminal performs federated learning, dropout may be performed as random dropout according to a dropout rate at each round by using masking of a federated learning model. As an example, a subnet may be determined when some nodes are randomly dropped out based on a dropout rate in fully connected neural networks (NNs) or in fully connected layers in a DNN, and subnet information thus determined may be transmitted to a terminal. Accordingly, information on a model received by a terminal may be reduced information in comparison with original model information. A terminal may receive determined subnet information and perform learning based on this. In addition, as an example, a terminal may perform learning based on subnet information, secure model diversity between rounds, and thus improve accuracy. Based on what is described above, federated learning may be performed in resource-constrained terminals, and a concrete method therefor will be described below.

In case federated learning is performed, computing power may be different according to each terminal, and each terminal needs to perform federated learning by considering such different computing power. As an example, a terminal with strong computing power may perform local model learning with high reliability based on a larger number of datasets, and a terminal with weak computing power may perform local model learning based on a relatively smaller number of datasets. Herein, a server (or base station) may update a global model by considering weight for the above-described local model learning. As an example, a server may be an edge server, a base station, an access point, and an entity with a global model for federated learning, but is not limited to a specific form. Hereinafter, for convenience of explanation, it will be referred to as a base station but may not be limited thereto.

As an example, it is possible to consider a case where each terminal does not learn an overall common model in existing federated learning but performs learning for each part of the common model by partitioning the model. Herein, a base station may receive partially-learnt information from each terminal and perform final global model update. Herein, as an example, the partitioning of the common model may be a method of dividing the model so that it is either orthogonal or non-overlapping, and then merging by learning through each terminal.

On the other hand, it is possible to consider a case where a terminal performs learning based on a dropout rate unlike existing federated learning. As an example, based on a constrained resource and power of a terminal, the terminal may perform learning for a local model based on a subnet where a part of a common model is dropped out from the model based on a dropout rate. The subnet may randomly drop out a partial region based on a dropout rate in order to prevent a dataset learnt by the terminal from being overfit. The terminal may perform learning based on the subnet, and thus a resource and power used in the terminal may be reduced. In addition, since the terminal performs learning for a local model with a partial region being dropped out based on dropout and transmits learning information to a base station, transmission capacity for transmitting information may also be reduced.

Herein, as an example, a method for determining a dropout rate, which is applied to federated learning in each terminal, may be needed. A subnet may be determined by randomly dropping out a partial region of a local model based on the determined dropout rate. A terminal may perform learning through data held based on a subnet and forward relevant information to a base station, and thus a learning amount and an information transmission amount may be reduced.

In addition, as an example, each terminal may be a data generating subject, and when learning is performed by transmitting data to a main edge server for learning, excessive traffic overhead may occur. On the other hand, in the case of federated learning, the learning is performed in each terminal, and thus traffic overhead may be reduced. In addition, as an example, because parallelism learning is performed as many times as the number of terminals participating in each learning, training latency may be reduced. In addition, as each terminal performs learning based on respective data, privacy protection may be easy. Hereinafter, a concrete method of performing federated learning based on what is described above will be described.

FIG. 6 is a view showing a method for performing federated learning according to an embodiment of the present disclosure. Referring to FIG. 6, a base station 610 (or server) may include global model information. As an example, the base station 610 may be a server, an edge server, an access point, and an entity performing transmission and reception but is not limited to a specific form. However, hereinafter, for convenience of explanation, the description will be based on the base station 610 but may not be limited thereto.

Referring to FIG. 6, the base station 610 may include a global model and forward information on the model to each of terminals 620-1, 620-2 and 620-3. Herein, each of the terminals 620-1, 620-2 and 620-3 may perform learning based on the received global model and give feedback information to the base station 610. The base station 610 may aggregate the feedback information from each of the terminals 620-1, 620-2 and 620-3 and update the global model, and thus perform federated learning. However, in the above-described method, learning may be constrained in terminals with constrained resources or power.

In consideration of what is described above, the base station 610 may determine a dropout rate for each of the terminals 620-1, 620-2 and 620-3 and generate a subnet (or subset) for each of the terminals 620-1, 620-2 and 620-3 based on the dropout rate. Then, the base station 610 may forward information on the generated subnet to each of the terminals 620-1, 620-2 and 620-3. Herein, the subnet may be a model determined through random dropout of some parameters from a global model based on the dropout rate that the base station 610 determines, and a learning amount in each terminal may be reduced accordingly. That is, the base station 610 may determine a dropout rate for each of the terminals 620-1, 620-2 and 620-3 and a subnet based on this and transmit information on the subnet to each of the terminals 620-1, 620-2 and 620-3.

Each of the terminals 620-1, 620-2 and 620-3 may perform learning for a local model, which is determined based on subnet information obtained from the base station 610, and give feedback on learnt information to the base station 610. Then, the base station 610 may update a global model based on the feedback information obtained from each of the terminals 620-1, 620-2 and 620-3.

Referring to FIG. 6, when performing update for federated learning based on what is described above, C² for any round and any terminal, overhead may be considered due to communication latency and computing latency expected in a terminal k. As an example, communication latency may be expressed by Equation 2 below. In Equation 2, a first value (term) may be communication latency occurring when a terminal is downloading a subnet, and a second value (term) may be latency occurring when learnt information is uploaded.

$${T}_{k}^{com} = \frac{{M}_{k} Q}{{B}_{k} {R}_{k}^{D}} + \frac{{M}_{k} Q}{{B}_{k} {R}_{k}^{U}} , 1 \leq k \leq K , \qquad [ Equation 2 ]$$

Here, in Equation 2, Mₖ may be the same as Equation 3, Mₖ may be the number of parameters expected in a subnet, and in Equation 3, M_{conv} may be the number of parameters of a convolution layer, and M_{full} may be the number of parameters of layers that are fully connected to an original DNN. In addition, in Equation 2, Q may be quantization bits for a single parameter, Bₖ may be a bandwidth allocated to the terminal k,

$${R}_{k}^{D}$$

may be downlink spectrum efficiency in the terminal k, and

$${R}_{k}^{U}$$

may be uplink spectrum efficiency in the terminal k. As an example, spectrum efficiency may be expressed as in Equation 4.

In addition, in Equation 4,

$${P}_{k}^{i}$$

may be downlink or uplink transmission power, Hₖ may be channel gain, and N₀ may be noise power.

$${M}_{k} = {M}_{conv} + {( 1 + {p}_{k} )}^{2} {M}_{full} \qquad [ Equation 3 ]$$

$${R}_{k}^{i} = {log}_{2} ( 1 + \frac{{P}_{k}^{i} {H}_{k}}{{N}_{0}} ) , i ∈ \{ U , D \} , \qquad [ Equation 4 ]$$

In addition, as an example, computing latency may be expressed by Equation 5. Here, Cₖ is computing overhead that updates a subnet, and may be expressed by Equation 6. Dₖ may be the number of samples learnt in the terminal k, and ƒₖ may be a computing clock frequency of the terminal k, of which a reciprocal may be computing speed accordingly.

$${T}_{k}^{cmp} = \frac{{C}_{k} {D}_{k}}{{f}_{k}} , 1 \leq k \leq K , \qquad [ Equation 5 ]$$

$${C}_{k} = {C}_{conv} + {( 1 + {p}_{k} )}^{2} {C}_{full} \qquad [ Equation 6 ]$$

Based on Equation 2 and Equation 5 described above, C² overhead as overall latency may be expressed by Equation 7. Herein, ultimate latency expected at each round may be determined as in Equation 8 based on a terminal with a largest number of latency among a plurality of terminals.

$${T}_{k} = {T}_{k}^{com} + {T}_{k}^{cmp} , 1 \leq k \leq K , \qquad [ Equation 7 ]$$

$$T = {max}_{k} {T}_{k} . \qquad [ Equation 8 ]$$

In addition, as an example, in case a dropout rate is determined, each parameter, which is dropped out to determine a subnet, may be randomly determined. As an example, a method of generating a subnet may be applied in fully connected neural networks or in fully connected layers within a DNN, but may not be limited thereto. As an example, an output of an i-th neuron in a l-th layer may be defined as ƒ_{l,i}(w_{l,i}). Herein, ƒ_{l,i}(⋅) may be an activation function, and w_{l,i} may be a parameter vector. Herein, a dropout technique may be applied to generating a subnet and be performed by deactivating each neuron with a probability pₖ at each round. Herein, the deactivation of the i-th neuron in the l-th layer with the probability pₖ may be performed based on Equation 9 below. Here,

$${m}_{l , i}^{( k )}$$

may be a mask of the neuron and be expressed by Equation 10 below.

$${\hat{f}}_{l , i} ( {w}_{l , i} ) = {m}_{l , i}^{( k )} {f}_{l , i} ( {w}_{l , i} ) . \qquad [ Equation 9 ]$$

$${m}_{l , i}^{( k )} = \{ \begin{matrix}\frac{1}{1 - {p}_{k}} , & with a probability of ( 1 - {p}_{k} ) , \\ 0 , & with a probability of {p}_{k} ,\end{matrix} . \qquad [ Equation 10 ]$$

As an example, in the above-described equation, pₖ may be a dropout rate, and (1−pₖ) may be a probability of existence. Accordingly, 1/(1−pₖ) as a scaling factor may ensure that \hat{ƒ}_{l,i}(w_{l,i}) is ƒ_{l,i}(w_{l,i}), and a subnet may be determined based on it.

Herein, when a dropout rate is determined, a server (or base station) may generate a unique subnet for each terminal at each round.

As an example, each round may be a single cycle where, after a subnet is determined for each terminal based on a determined dropout rate, a server (or base station) updates a global model by performing learning based on the subnet at each terminal. Herein, each subnet may include every convolution layer and a part of the fully connected layers. Herein, the part of the fully connected layers may be randomly determined based on a dropout rate, and this is the same as described above. Based on what is described above, each terminal may reduce each of communication overhead and computing overhead as C² overhead. As an example, C² overhead may be latency in overall learning, which is determined based on what is described above. Resources (e.g. time, frequency) and transmission power allocated to each terminal may all be used. In addition, a method of configuring a subnet based on a dropout rate may improve learning performance. As an example, based on what is described above, testing accuracy as learning performance may be improved.

As an example, for any round and any terminal, if a dropout rate of a k-th terminal is pₖ, latency given at each round is T, a gain of a changing channel is Hₖ, an allocated bandwidth is Bₖ, and transmission power is

$$\{ {P}_{k}^{D} , {P}_{k}^{U} \} ,$$

a dropout rate may be expressed by Equation 11 below. Herein, the function ƒ(⋅) may be determined based on Equation 12 below but is not limited thereto.

$${p}_{k} = f ( T , {H}_{k} , {B}_{k} , {P}_{k}^{D} , {P}_{k}^{U} ) . \qquad [ Equation 11 ]$$

$${p}_{k} = 1 - \sqrt{\frac{T - {T}_{k}^{conv}}{{T}_{k}^{full}}} , \qquad [ Equation 12 ]$$

Here,

$${T}_{k}^{conv} and {T}_{k}^{full}$$

may be aggregates of C² latency for updating all the convolution layers and a part of the fully connected layers, respectively, in an original DNN for each terminal, and may be determined based on Equation 13 below.

$${T}_{k}^{i} = \frac{{M}_{i}}{{B}_{k}} ( \frac{1}{{R}_{k}^{D}} + \frac{1}{{R}_{k}^{U}} ) + \frac{{C}_{i} {D}_{k}}{{f}_{k}} for i ∈ \{ conv , full \} , \qquad [ Equation 13 ]$$

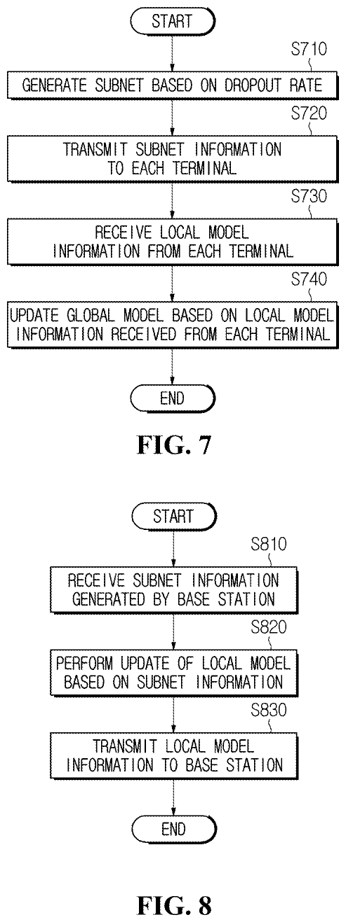

FIG. 7 is a view showing a method for performing federated learning based on a dropout rate according to an embodiment of the present disclosure. Referring to FIG. 7, a base station may have a global model, and the global model may be updated based on information on local model learning performed by each terminal. Herein, one round may be a cycle where the global model is updated based on learning information on a local model obtained from each terminal. As an example, the base station may generate a subnet based on a dropout rate determined for each terminal at each round (S710). That is, a dropout rate and a subnet may be determined for each terminal. Herein, the dropout rate may be determined by a policy that is derived by considering C² overhead based on a requirement set based on at least any one of round latency, a channel gain, a bandwidth, and DL/UL power. Herein, the subnet may be determined as some nodes are randomly dropped out based on a dropout rate in fully connected neural networks (NNs) or in fully connected layers in a DNN, and information on a subnet thus determined may be transmitted to each terminal (S720). That is, each terminal may obtain subnet information allocated by the base station as model information. Next, each terminal may update each local subnet based on local datasets of the each terminal. Next, each terminal may transmit the updated local model information to the base station. That is, the base station may receive the local model information from each terminal (S730). Next, parameters of each subnet corresponding to each terminal may be updated by an updated local model value. In addition, other parameters may also be updated based on the above-described value and previous round information, and thus a DNN may be constructed for each terminal. Next, the base station may update the global model through every DNN constructed at each terminal (S740).

FIG. 8 is a view showing a method for performing federated learning based on a dropout rate according to an embodiment of the present disclosure. Referring to FIG. 8, a base station may have a global model, and the global model may be updated based on information on local model learning performed by each terminal. Herein, one round may be a cycle where the global model is updated based on learning information on a local model obtained from each terminal. As an example, the base station may generate a subnet based on a dropout rate determined for each terminal at each round. As an example, a dropout rate and a subnet may be determined for each terminal. Herein, the dropout rate may be determined by a policy that is derived by considering C² overhead based on a requirement set based on at least any one of round latency, a channel gain, a bandwidth, and DL/UL power. Herein, the subnet may be determined as some nodes are randomly dropped out based on a dropout rate in fully connected neural networks (NNs) or in fully connected layers in a DNN, and information on a subnet thus determined may be transmitted to each terminal. That is, each terminal may obtain subnet information allocated by the base station as model information (S810). Next, each terminal may update each local subnet based on local datasets of the each terminal (S820). Next, each terminal may transmit the updated local model information to the base station (S830). Parameters of each subnet corresponding to each terminal may be updated by an updated local model value. In addition, other parameters may also be updated based on the above-described value and previous round information, and thus a DNN may be constructed for each terminal. Next, the base station may update the global model through every DNN constructed at each terminal.

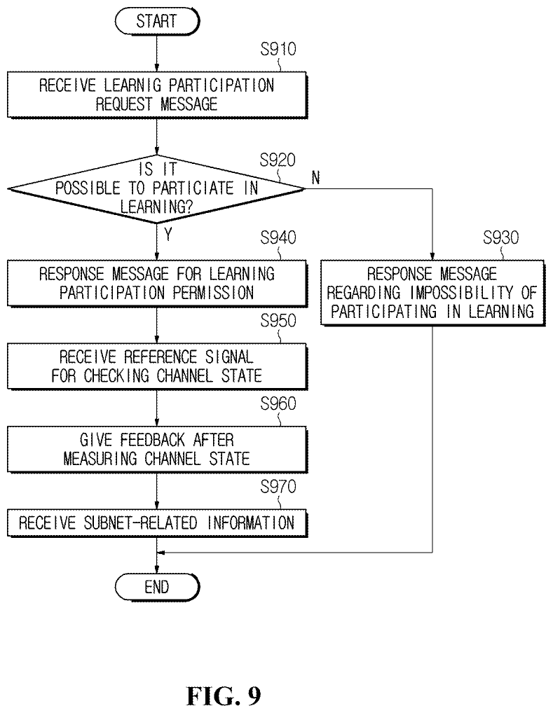

FIG. 9 is a view showing a method for operating a terminal participating in federated learning according to an embodiment of the present disclosure.

As an example, an edge server (or base station) may perform DNN learning based on information (e.g. image, sensing data) generated from a plurality of terminals or IoT devices. Then, the edge server (or base station) may perform inference or classification so that a task may use federated learning.

In addition, as an example, referring to FIG. 9, an edge server (or base station) may determine terminals participating in learning for federated learning and perform learning for the federated learning based on it. Specifically, each terminal may receive a learning participation request message from the edge server (or base station) (S910). At this time, each terminal may determine whether or not to participate in the federated learning by considering a local dataset currently generated and capability of the terminal. Herein, in case a terminal is incapable of participating in the learning based on its capability and local dataset information (S920), the terminal may transmit a response message about inability to participate in the learning to the edge server (or base station) (S930). On the other hand, in case the terminal is capable of participating in the learning (S920), the terminal may transmit a response message about permission to participate in the learning to the edge server (base station) (S940). As an example, when a terminal participates in learning, the terminal may forward capability information of the terminal and volume information of a local dataset together. Herein, the capability information of the terminal may include a clock frequency of the terminal, a battery, information on available transmission power, and other learning-related information but is not limited to a specific embodiment. Next, the edge server (or base station) may transmit a reference signal for identifying channel state information between the edge server (base station) and a terminal to each terminal. That is, a terminal may receive a reference signal for identifying a channel state from the edge server (base station) (S950). Next, the terminal may measure the channel state based on the reference signal and give feedback to the edge server (base station) (S960). The edge server (or base station) may determine a policy for the above-described dropout rate based on at least any one of channel information, terminal capability information, power information of the edge server (or base station), and radio resource information, and determine a dropout rate according to the determined policy.

Next, the edge server (or base station) may construct a subnet by randomly dropping out some nodes based on the dropout rate, which is the same as described above. Next, the edge server (or base station) may forward subnet-related information to each terminal (S970). Herein, as an example, the edge server (or base station) may construct a subnet for each terminal and forward subnet-related information to each terminal through multicasting. As an example, the subnet-related information may include at least any one of a neural network component index and a value. As another example, the edge server (or base station) may perform global model broadcasting and neural network index multicasting corresponding to a subnet, but is not limited to the above-described embodiment. Based on what is described above, each terminal may obtain information on each subnet, perform learning based on a local dataset for each terminal, and give feedback to the edge server (or base station).

As an example, the above-described operation may be performed based on a single round, and the above-described operation may be repeated at each round and not be limited to a specific form.

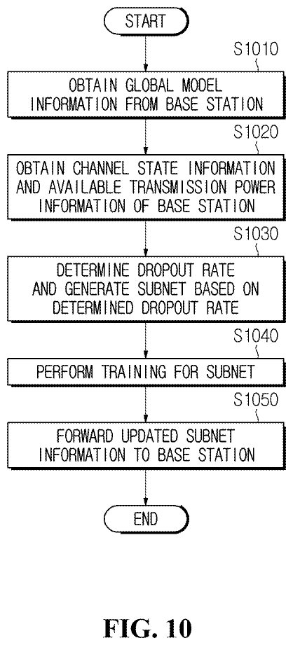

FIG. 10 is a view showing a method for performing learning by determining a dropout rate in a terminal according to an embodiment of the present disclosure.

As an example, because determination of a dropout rate is performed by considering asymmetric bandwidth allocation according to each terminal that considers an overall status of radio resources, the dropout rate may be determined by a server (or base station) that performs centralized access.

However, as an example, in case uniform bandwidth allocation to each terminal is considered, each terminal may perform dropout rate determination and subnet configuration on its own. Specifically, referring to FIG. 10, each terminal may obtain global model information from a base station (S1010). Next, each terminal may receive channel state information, available transmission power information of the base station, and other information for dropout rate determination, but is not limited to the above-described embodiment (S1020). Net, each terminal may determine a dropout rate and generate a subnet by randomly performing dropout based on the determined dropout rate (S1030). Each terminal may perform training based on the generated subnet (S1040) and forward updated subnet information to the base station (S1050). As an example, the base station may receive the updated subnet information from each terminal and update the global model based on the information.

In a wireless communication system, a base station may update a global model through the above-described dropout rate and a subnet determined based on the dropout rate, and this is the same as described above.

Herein, an image inference task may be considered as regards a specific operation of performing a task by the base station using a global model. As an example, the base station may forward a dropout rate and subnet information determined based on the dropout rate to each terminal. Next, each terminal may perform training through generated image information and update subnet information. Next, each terminal may forward the updated subnet information to the base station, and the base station may update the global model based on the subnet information received from the terminal. Next, the base station may perform inference based on the global model. As an example, the inference may mean an operation of applying actual new input data though the global model made through learning and applying a result. Herein, the base station may receive image information generated in each terminal. The base station may apply the image information received from each terminal to the global model and derive an output value.

As an example, a global model may be a model that has a compressed feature vector of an estimated channel as input and reconstructed estimated channel information as output. Herein, each terminal may estimate channel information based on a reference signal received a base station and report the estimated channel information to the base station. The base station may derive a compressed feature vector based on estimated channel information obtained from each terminal and apply the feature vector to a global model to obtain reconstructed estimated channel information.

Herein, as an example, a base station may forward subnet information based on a dropout rate to each terminal, and this is the same as described above. In addition, each terminal may perform training by receiving a reference signal from a base station, obtaining a measured value through channel measurement, and deriving a compressed feature vector of an estimated channel. Then, each terminal may update subnet information based on training and forward the updated subnet information to a base station. Herein, the base station may update a global model through information received from each terminal. Thus, the base station may obtain the updated global model information, perform inference based on channel estimation information received from each terminal, and obtain reconstructed estimated channel information as output information.

As another example, a base station in a wireless communication system may perform an inference task based on a global model and subnet information. Specifically, the base station may perform a channel status information (CSI) inference task. Herein, the base station may receive a reference sequence passing a channel from each terminal. A global model may be a model that has a reference sequence received from each terminal as input and overall uplink channel information as output. The base station may receive reference sequence pattern information from each terminal, apply the information to the global model to perform inference for information on uplink channels, and thus infer uplink channel information. Herein, as an example, the base station may forward subnet information based on a determined dropout rate to each terminal. In addition, each terminal may obtain channel-related information based on a reference signal from the base station. Each terminal may perform training based on the channel-related information and update a subnet through it. Then, each terminal may forward the updated subnet information to the base station. The base station may update a global model based on the updated subnet information obtained from each terminal. Then, the base station may infer channel information by applying a reference sequence received from each terminal to the updated global model.

Since examples of the above-described proposed method may also be included as one of the implementation methods of the present disclosure, it is apparent that the examples may be regarded as a kind of proposed methods. In addition, the above-described proposed methods may be implemented independently, or some of the proposed methods may be combined (or merged) to be implemented. A rule may be defined such that the BS provides the information on whether the proposed methods are applied (or information on the rules of the proposed methods) to the UE through a predefined signal (e.g., a physical layer signal or a higher layer signal).

The present disclosure may be carried out in other specific forms than those set forth herein without departing from the technical idea and essential features of the present disclosure. The above detailed description is therefore to be construed in all aspects as illustrative and not restrictive. The scope of the disclosure should be determined by a reasonable interpretation of the appended claims, and all changes coming within the equivalent range of the present disclosure are intended to be embraced therein. In addition, claims not explicitly cited by each other in the appended claims may be combined to configure an embodiment of the present disclosure or included in a new claim by a subsequent amendment after the application is filed.

Embodiments of the present disclosure are applicable to various wireless access systems. Examples of the various wireless access systems include a 3rd Generation Partnership Project (3GPP) system or a 3GPP2 system.

Besides the various wireless access systems, the embodiments of the present disclosure are applicable to all technical fields in which the wireless access systems find their applications. Moreover, the proposed method is also applicable to mmWave THz communication systems using an ultra-high frequency band.

Additionally, the embodiments of the present disclosure are applicable to various applications such as a self-driving vehicle and a drone.

1. A method performed by a terminal in a wireless communication system, the method comprising:
receiving, from a base station, a reference signal for measuring channel state information;
performing measurement based on the received reference signal;
transmitting, to the base station, a measurement report based on the performed measurement;
receiving first information determined by the base station based on the measurement report; and
performing learning based on the first information related to a subnet,
wherein the subnet is determined by randomly dropping out of some nodes from a global model based on a dropout rate.

2. The method of claim 1, wherein the dropout rate is determined for each terminal by the base station through a policy for determining the dropout rate.

3. The method of claim 2, wherein the policy is determined based on at least one of channel information, terminal capability information, power information of the base station, and radio resource information.

4. The method of claim 3, wherein the case that the subnet is determined by the base station, the dropout rate is determined by the base station.

5. The method of claim 4, wherein the global model is determined based on at least one of fully connected neural networks (NNs) and fully connected layers in DNN.

6. The method claim of 1, wherein the terminal constructs a local model based on the subnet and performs learning through a local dataset obtained based on the constructed local model.

7. The method of claim 6, wherein the terminal forwards second information on the performed learning based on the local dataset to the base station, and
wherein the global model is updated by the base station based on each piece of learning information received from each of terminals.

8. The method of claim 1, wherein an update for the global model, which the base station has, is performed at each round,
wherein the terminal receives a learning participation request message for learning of a first round, and
wherein, based on the terminal being capable of participating in the learning of the first round, the terminal transmits a response message for learning participation permission to the base station.

9. The method of claim 8, wherein the terminal determines whether to participate in the learning of the first round, based on at least one of a generated local dataset and capability of the terminal.

10. The method of claim 9, wherein, based on the terminal transmitting the response message for learning participation permission to the base station, the terminal transmits information on the capability of the terminal and volume information of the local dataset to the base station together.

11. The method of claim 10, wherein the information on the capability of the terminal is determined by considering at least one of a clock frequency, a battery, and available transmission power information of the terminal.

12. The method of claim 11, wherein the base station is at least one of a server, an edge server, an access point, and an entity with a global model.

13. (canceled)

14. A terminal in a wireless communication system, comprising:
a transceiver; and
a processor coupled with the transceiver,
wherein the processor is configured to:
receive, from a base station, a reference signal for measuring channel state information,
perform measurement based on the received reference signal,
transmit, to the base station, a measurement report based on the performed measurement
receive first information determined by the base station based on the measurement report, and
perform learning based on the first information related to subnet,
wherein the subnet is determined by randomly dropping out of some nodes from a global model based on a dropout rate.

15. A base station in a wireless communication system, comprising:
a transceiver; and
a processor coupled with the transceiver,
wherein the processor is configured to:
transmit a reference signal for measuring channel state information to at least one or more terminals,
receive a measurement report from the at least one or more terminals,
determine a dropout rate and a subnet for the at least one or more terminals, and
transmit first information related to the determined subnet to the at least one or more terminals,
wherein the subnet is determined by randomly dropping out of some nodes from a global model based on a dropout rate.

16-17. (canceled)

18. The method of claim 1, the method further comprising:
determining the dropout rate based on the first information,
generating the subnet based on the dropout rate,
wherein the first information includes third information related to the dropout rate.
